(19) United States
(12) Patent Application Publication
(10) Pub. No.: US 2026/0335943 A1
(43) Pub. Date: Oct. 29, 2026

(54) WILDLIFE DETECTION, DETERRENT, AND SELF-CLEANING SYSTEM AND METHOD FOR ENVIRONMENTAL INSTRUMENTATION

(71) Applicant: PROA HOLDINGS PTY LTD, Balwyn VIC (AU)

(72) Inventors: William Clarke, Balwyn (AU); Victor Depoorter Ruelle, Balwyn (AU); Alistair Knox, Balwyn (AU)

(21) Appl. No.: 19/099,102

(22) PCT Filed: Jul. 29, 2022
(86) PCT No.: PCT/AU2022/050805

§ 371 Date: Jan. 28, 2025

(51) Int. Cl. B08B 3/14; A01M 29/06; G01F 23/00; H02S 40/10

(52) U.S. Cl. CPC B08B 3/14; A01M 29/06; G01F 23/0007; H02S 40/10

(57) ABSTRACT

Described is a self-cleaning system for cleaning an environment monitoring apparatus having an active area, the system includes: a reservoir; a cleaning system in fluid communication with the reservoir and configured for cleaning of the active area by directing water supplied by the reservoir onto the active area; a water collection system for collecting and inputting into the self-cleaning system water external to the self-cleaning system, wherein the water collection system is in fluid communication with the reservoir; and a filtration system for filtering water within the self-cleaning system.

### FIELD OF THE INVENTION

The invention generally relates to systems and methods for self-cleaning of an environment monitoring apparatus. The embodiments herein described also relate to systems and methods for deterring animals from the vicinity of the environment monitoring apparatus.

### BACKGROUND TO THE INVENTION

There exists a class of environmental monitoring instruments used for a range of applications including, weather sensing, solar resource monitoring and solar forecasting, for which the instrument lenses must be kept clean to produce useful data. Examples of such instruments include sky cameras and pyranometers.

When installed outdoors the lenses of these instruments become, over time, soiled by airborne particles (e.g. dust, dirt, pollen, etc.) and by wildlife (e.g. birds). To maintain the cleanliness of the lenses the instruments are typically manually cleaned at regular intervals. Manually cleaning has several drawbacks, such as the associated labour cost, the reliability of manual cleaning (scheduled cleaning events can easily be missed), access to the remote location of environmental monitoring instruments, and difficulty accessing the instruments (high access equipment is often required).

### SUMMARY OF THE INVENTION

According to an aspect of the present invention, there is provided a system for cleaning an environment monitoring apparatus having an active area, the system comprising: a reservoir; a self-cleaning system in fluid communication with the reservoir and configured for cleaning of the active area by directing water supplied by the reservoir onto the active area; a water collection system for collecting and inputting into the self-cleaning system water external to the self-cleaning system, wherein the water collection system is in fluid communication with the reservoir; and a filtration system for filtering water within the self-cleaning system.

The filtration system optionally comprises a first filter unit in fluid communication with, and between, the reservoir and the self-cleaning system. The system may comprise a first pump for pumping water from the reservoir to the first filter unit and subsequently to the self-cleaning system. The first filter unit may comprise a deionising filter. The first filter unit may comprise a carbon filter arranged to filter received water before said deionising filter.

The filtration system optionally comprises a second filter unit in fluid communication with, and between, the reservoir and the first filter unit. The second filter unit may comprise a strainer. The second filter unit may be arranged at a suction side of the first pump.

In use, a direction of flow of water is preferably from the reservoir through the first filter unit and on to the self-cleaning system.

The water collection system optionally comprises at least one first collector arranged to receive water expelled by the self-cleaning system, such that at least a portion of water used for cleaning the active area is captured by the at least one first collector. At least one first collector may comprise a collection tray in fluid communication with the reservoir arranged such that captured water is directed to the reservoir.

The water collection system optionally comprises at least one second collector arranged to receive environmental water, such as rain. At least one second collector may comprise a collection tray in fluid communication with the reservoir arranged such that captured water is directed to the reservoir. At least one first collection tray may be a same physical collection tray as at least one second collection tray.

The water collection system typically utilises gravity to deliver captured water to the reservoir.

The system optionally further comprises a deterrence system for deterring animals from a vicinity of an environment monitoring apparatus. The deterrence system may comprise: a detector system comprising at least one sensor configured to generate a presence signal indicative of the presence of an object within a predefined vicinity of the environment monitoring apparatus; a deterrence processing system; and repulsion system, wherein the deterrence processing system is configured to: monitor the presence signal; determine, from the presence signal, the presence of an object within the predefined vicinity of the environment monitoring apparatus; and communicate a command for the repulsion system to perform a sequence of one or more repulsion events actions in response to determining that an object is present, and wherein the repulsion system is configured to: perform one or more repulsion events responsive to receipt of the command from the deterrence processing system. The deterrence system may be configured to move a cleaning arm of the self-cleaning system through a path in which at least a portion of the cleaning arm moves within the vicinity of the environment monitoring apparatus such as to deter animals from a vicinity of an environment monitoring apparatus.

The system may further comprise a solar power generator and a battery for providing electrical power to components of the system. Advantageously, a solar powered-based electrical power arrangement can enable “standalone operation” without requiring access to an electrical grid, thereby enabling flexibility in installation location.

The system may be configured for remote operation.

The system optionally further comprises a communication system configured to communicate between an external computer and the self-cleaning system; and wherein the self-cleaning system is further configured to receive commands from the external computer via the communication system for controlling the cleaning processing system, environment monitoring apparatus and/or self-cleaning system remotely, and/or to communicate monitoring information, wherein the communication system utilises a wireless wide area communications protocol. The system may further comprise: a reservoir level sensor configured to monitor an amount of water present within the reservoir, wherein the self-cleaning system is configured to identify a low water event corresponding to an amount of water in the reservoir, as detector by the reservoir level sensor, being below a threshold amount, and to communicate an indication of the low water event to the external computer.

According to another aspect of the present invention, there is provided an environment monitoring apparatus comprising the system of the previous aspect, wherein the environmental monitoring apparatus comprises an active area for monitoring an environment of the environment monitoring apparatus, and wherein the self-cleaning system is configured for cleaning said active area. Typically, the environment monitoring apparatus is configured for optical sensing of environmental electromagnetic radiation.

According to the present disclosure, there is provided a deterrence system for deterring animals from a vicinity of an environment monitoring apparatus, the system comprising: a detector system comprising at least one sensor configured to generate a presence signal indicative of the presence of an object within a predefined vicinity of the environment monitoring apparatus; a deterrence processing system; and a repulsion system, wherein the deterrence processing system is configured to: monitor the presence signal; determine, from the presence signal, the presence of an object within the predefined vicinity of the environment monitoring apparatus; and communicate a command for the repulsion system to perform a sequence of one or more repulsion events actions in response to determining that an object is present, and wherein the repulsion system is configured to: perform one or more repulsion events responsive to receipt of the command from the deterrence processing system.

The environment monitoring apparatus may be mounted on a pole and/or may be configured for obtaining sensor measurements of at least a portion of the sky, such as a skycam or pyranometer.

Optionally, the detector system comprises one or more of: an infrared detector; a motion detector; a time-of-flight camera; a microwave movement sensor; an ultrasonic sensor; a photoelectric sensor; a laser range-finding sensor; and a capacitive proximity sensor. The detector system may be mounted at a distance from the environment monitoring apparatus with at least one sensor facing the optical apparatus.

Optionally, the deterrence processing system is further configured to: perform a first temporal check to determine whether the presence signal has indicated the presence of the object for at least a first predefined time, and wherein the command is only communicated when the temporal check determines that the object has been present for the predefined time.

The sequence may comprise one repulsion event. The one repulsion event may comprise one or more of: at least one non-physical repulsion action; and at least one physical repulsion action. The at least one non-physical repulsion action may be selected from a visual repulsion action and an audible repulsion action. The at least one physical repulsion action may include moving an object into a vicinity of the optical apparatus.

Alternatively, the sequence may comprise at least an initial repulsion event and a subsequent repulsion event. The deterrence processing system may be further configured to: communicate a first command for the repulsion system to perform the initial repulsion event in response to determining that an object is present; perform a second temporal check to determine whether the presence signal has indicated the presence of the object for at least a second predefined time subsequent to the performance of the initial repulsion event; communicate a second command for the repulsion system to perform the subsequent repulsion event in response to determining that the object is still present after the second predefined time. The initial repulsion event may comprise one or both of: a visual repulsion action; and an audible repulsion action. The subsequent repulsion event may comprise a physical repulsion action.

A physical repulsion action may comprise moving a cleaning arm of a self-cleaning system through a path in which at least a portion of the cleaning arm moves within the vicinity of the environment monitoring apparatus. Optionally the self-cleaning system is according to the aspects mentioned below.

In an embodiment, the distance discrimination system is further configured to: determine a distance between the environment monitoring apparatus and a detected object; communicate a command for the repulsion system to perform one or more repulsion event only in response to determining that the object is further than a predefined minimum distance.

In an embodiment, the environment monitoring apparatus comprises an optical apparatus. The environment monitoring apparatus may comprise a substantially upward facing sensing portion.

The system may be configured to record in a log and/or the communicate to an external computer instances of undertaking one or more repulsion events actions. Optionally, the system further comprises a communication system configured to receive communications from an external computer, said communications including commands from the external computer via the communication system for controlling the deterrence processing system, environment monitoring apparatus and/or repulsion system remotely. Also, or alternatively, the system may also further comprise a communication system configured to send communications to an external computer, said communications including monitoring communications.

According to another aspect of the present disclosure, there is provided a deterrence method for deterring animals from a vicinity of an environment monitoring apparatus, comprising the steps of: generating a presence signal indicative of the presence of an object within a predefined vicinity of the environment monitoring apparatus; monitoring the presence signal; determining, from the presence signal, the presence of an object within the predefined vicinity of the environment monitoring apparatus; and performing one or more repulsion actions responsive to receipt of the command from the deterrence processing system.

According to another aspect of the present disclosure, there is provided a self-cleaning system for cleaning an environment monitoring apparatus, the system comprising: a cleaning arm having a nozzle; a drive unit configured to move the cleaning arm about a path; a reservoir in fluid communication with the nozzle; a pump; and a cleaning processing module configured to control operation of the drive unit and the pump, wherein the cleaning processing module is configured to: control the drive unit to move the cleaning arm about the path; and control the pump to cause a movement of liquid from the reservoir to the nozzle such that the liquid exits the nozzle, wherein the path and nozzle are configured such that the liquid is caused to contact an active area of the environment monitoring apparatus, thereby causing cleaning of the environment monitoring apparatus.

Optionally, the environment monitoring apparatus is mounted on a structure, such as a pole, and/or configured for obtaining senor measurements of at least a portion of the sky, such as a skycam. The cleaning arm and nozzle may be located in proximity to the environment monitoring apparatus and the reservoir may be found in proximity to a base of the pole.

Optionally, the cleaning processing module is configured to control cleaning of the environment monitoring apparatus periodically and/or according to a predefined schedule.

The fluid communication may comprise flexible and/or non-flexible tubing.

According to an embodiment, the environment monitoring apparatus comprises an optical apparatus. The environment monitoring apparatus may comprise a substantially upward facing sensing portion.

In an embodiment there is provided a self-cleaning system wherein the nozzle is one of multiple nozzles, the system further comprising a valve system comprising at least one valve for controlling activation of the multiple nozzles, wherein an activated nozzle allows liquid to exit, and wherein the cleaning processing module is further configured to: control the pump and valve(s) to cause a movement of liquid from the reservoir to selected one or more nozzles such that the liquid exits said selected nozzle(s) to contact a part of the active area of the environment monitoring apparatus, and thereafter cause a further movement of liquid to another selected one or more of the multiple nozzles such that the liquid contacts another part of the active area.

The cleaning processing module can be further configured to control the pump and valve(s) to cause movement of liquid such that it is directed to individual nozzles in succession thereby performing a sequence of nozzle emissions such that the substantially the entire active area is contacted.

The cleaning arm is one of multiple cleaning arms and/or the sensing portion is one of multiple sensing portions.

In another embodiment, there is provided a self-cleaning system further comprising a communication system configured to communicate between an external computer and the self-cleaning system; and wherein the self-cleaning system is further configured to receive commands from the external computer via the communication system for controlling the cleaning processing system, environment monitoring apparatus and/or self-cleaning system remotely, and/or to communicate monitoring information.

The system may be further configured to record in a log and/or the communicate to an external computer instances of undertaking one or more repulsion events actions.

According to another aspect of the present disclosure, there is provided a self-cleaning method for cleaning an environment monitoring apparatus, comprising the steps of: moving a cleaning arm having a nozzle along a path; pumping liquid from a reservoir to the nozzle thereby causing the liquid to exit the nozzle as the cleaning arm moves along the path, wherein the path and nozzle are configured such that the liquid is caused to contact an active area of the environment monitoring apparatus, thereby causing cleaning of the environment monitoring apparatus.

In an embodiment, there is provided a self-cleaning method further comprising the steps of: providing at least one cleaning arm with multiple nozzles; controlling at least one valve to direct the pumped liquid from the reservoir to selected one or more nozzles in succession; and wherein the valve(s), nozzles and/or path are configured such that the liquid exits each nozzle in succession in a sequence of nozzle emissions to contact substantially the active area thereby causing cleaning of the optical apparatus with maximal water pressure from each nozzle.

Optionally, the pump, path and/or nozzle(s) can be configured to cause the liquid to exit the nozzle(s) at low pressure over substantially the active area thereby soaking the active area before cleaning of the optical apparatus.

According to another aspect of the present disclosure, there is provided a deterrence system for deterring animals from a vicinity of an environment monitoring apparatus, the system comprising: at least one sensor configured to detect the presence of an object within a predefined vicinity of the environment monitoring apparatus; a deterrence processing system; and a repulsion system for performing one or more repulsion actions for repelling the object, wherein the deterrence processing system is configured to: determine the presence of an object within the predefined vicinity of the environment monitoring apparatus; and control the repulsion system to perform a sequence of one or more repulsion events actions in response to determining that an object is present.

According to another aspect of the present disclosure, there is provided a deterrence method for deterring animals from a vicinity of an environment monitoring apparatus, comprising the steps of: determining the presence of an object within the predefined vicinity of the environment monitoring apparatus; and performing one or more repulsion actions responsive to determining the presence of the object.

According to another aspect of the present disclosure, there is provided a solar farm comprising one or more deterrence systems and/or self-cleaning systems according to the above aspects.

An operator of a deterrence system(s) and/or self-cleaning system(s) may be contractually required to maintain the associated environment monitoring apparatus(es) at a defined level of cleanliness (e.g. to ensure that the environmental monitoring performed y the apparatus(es) is accurate). The systems and methods described herein may advantageously improve the confidence of both the operator(s) of the deterrence system(s) and/or self-cleaning system(s) and the operator(s) of the environment monitoring apparatus(es) that the environment is being accurately monitored due to the ongoing autonomous deterrence and/or self-cleaning actions performed by the described embodiments. A further advantage may be the reduce need for users to physically visit, inspect, and/or maintain the environment monitoring apparatus(es) due to the improved confidence that the environment monitoring apparatus(es) are being maintained by the deterrence system(s) and/or self-cleaning system(s), which advantageously are configured to run autonomously for extended periods of time. An advantage also resides in the reduced need for a user to refill the self-cleaning system by enabling collection and filtering of water from the local environment.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawings, in which:

FIG. 1 shows a deterrence system according to an embodiment;

FIG. 2 shows an embodiment wherein an optical apparatus mounted atop a pole;

FIG. 3 shows a method implemented by a deterrence processing module according to an embodiment;

FIG. 4 shows a self-cleaning system according to an embodiment;

FIG. 5 shows a relationship between a cleaning processing module, a pump, and a drive unit;

FIG. 6 shows another method implemented by a deterrence processing module according to an embodiment;

FIG. 7 shows a modification to the method of FIG. 3 whereby a repulsion even does not occur if an object is too close; and

FIGS. 8 and 9 show embodiments comprising a water collection system integrated with the self-cleaning system.

### DESCRIPTION OF EMBODIMENTS

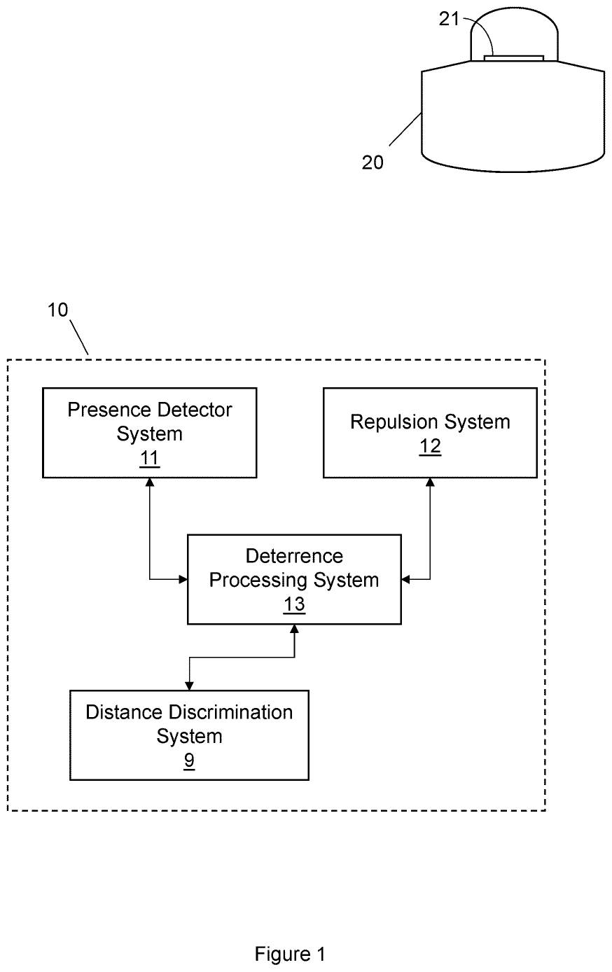

FIG. 1 shows schematically a deterrence system 10 according to an embodiment. The system 10 may be used for deterring animals (such as birds) from being in the vicinity of or landing on an environment monitoring apparatus 20 for monitoring at least one environment variable. The system 10 comprises a detector system 11, and a repulsion system 12, each interfaced with a deterrence processing module 13.

According to this embodiment, the environment monitoring apparatus 20 is an optical apparatus typically comprising an optical sensor 21 configured to receive electromagnetic radiation—this can be optical radiation, infrared radiation, ultraviolet radiation, and/or any other required spectra. The electromagnetic radiation, in this case, corresponds to an environment variable. Advantageously, the environment monitoring apparatus 20 may be suitable for ongoing use in a location that is infrequently monitored by people and/or difficult to access—for example, in a country or desert region, or in an urban environment atop a tall mast. The environment monitoring apparatus 20 is configured to record and/or transmit data corresponding to the sensed environment variable—for example, an optical apparatus can be configured to record a time series of images (which may be a video). The quality of operation of the environment monitoring apparatus 20 may be dependent on a consistent sensing efficiency. Such an optical apparatus may be configured for imaging the sky and may be selected from: sky/cloud cameras; pyranometers; pyrheliometers, UV sensors, Lidar, and ceilometers.

In an embodiment, the environment monitoring apparatus 20 includes a non-optical apparatus (separately or in addition to an optical sensor 21). An example non-optical apparatus is a SODAR device. For the purposes of the present disclosure, it is assumed that the environment monitoring apparatus 20 comprises an optical apparatus.

An example environment monitoring apparatus 20 is used for weather monitoring. Such an environment monitoring apparatus 20 may be a “sky camera”, which are of increasing importance to solar farms. For example, a sky camera is utilised by the present Applicant's solar forecasting system (Proa Forecasting System (PFS)) as described at the following resources:

https://proa.energy/solutions/expert-services/
“Proa Analytics Solar Forecasts Project - LESSONS LEARNT REPORT 2”
https://arena.gov.au/assets/2020/07/proa-analytics-solar-forecasting-lessons-learnt-
report-2.pdf.

A particular problem can be the presence of birds or bird droppings, which may have a profound influence on the operation of the environment monitoring apparatus 20. Birds may roost, nest, or defecate on the environment monitoring apparatus 20, compromising the accuracy of the collected data, and diminishing its value.

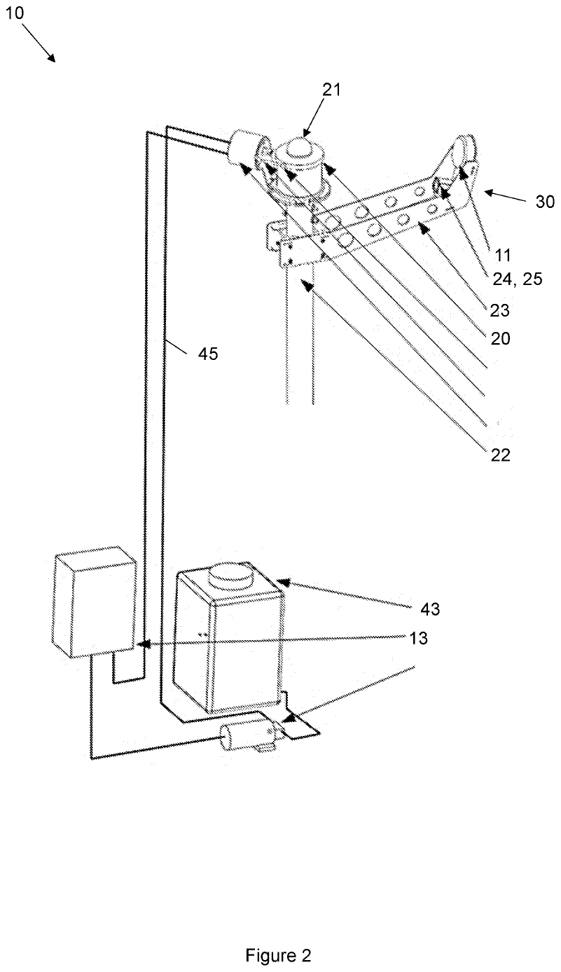

FIG. 2 shows an embodiment of system 10, wherein the environment monitoring apparatus 20 is mounted atop a pole 22. More generally, the environment monitoring apparatus 20 may be mounted onto (e.g. atop) a structure, such as a building. As shown, the environment monitoring apparatus 20 monitors the sky—in this case, the optical sensor 21 corresponds to an upward facing camera 21. The system 10 comprises detector system 11, which can comprise a motion detector depending on the implementation. The detector system 11, according to an embodiment, is configured to generate a presence signal indicative of the presence of an object, such as an animal, with a vicinity of the environment monitoring apparatus 20. In an embodiment, the presence signal is also generated when the animal is in physical contact with the environment monitoring apparatus 20. For example, for detection, the maximum distance from the environment monitoring apparatus 20 can be between 1 metre and 3 metres, depending on the implementation.

The detector system 11 is interfaced with the deterrence processing module 13 such that the presence signal is communicated to the deterrence processing module 13. In an embodiment, the presence signal directly indicates the presence of an animal—for example, the presence signal may comprise an indication of state. In another embodiment, the presence signal is processed by the deterrence processing module 13, which determines, based on a property of the presence signal, whether an animal is present. For example, the presence signal may correspond to an analogue signal which is analysed by the deterrence processing module 13. In either case, the deterrence processing module 13 is configured to identifying from the presence signal that an animal is present within a vicinity of the environment monitoring apparatus 20.

According to an embodiment, as shown in FIG. 2, the detector system 11 is located at a distance from the environment monitoring apparatus 20. In this embodiment, arm 23 is provided extending from pole 22, with a distal end 30 of the arm 23 having attached the detector system 11. The detector system 11 is oriented such as to detect the presence of an animal in the vicinity of the environment monitoring apparatus 20.

The detector system 11 can comprise, for example, at least an infrared detector configured to identify the presence of an animal. Other examples include one or more of: a microwave movement sensor (utilising the Doppler effect); an ultrasonic sensor (utilising time of flight); a photoelectric sensor (for example, either through-beam or reflected-beam); a laser range-finding sensor; and a capacitive proximity sensor.

According to an embodiment (not shown), the detector system 11 is located with one or more detectors next to the environment monitoring apparatus 20. Such detectors may be facing outwards (i.e. away from the environment monitoring apparatus 20) and are configured to identify animals as they approach the environment monitoring apparatus 20.

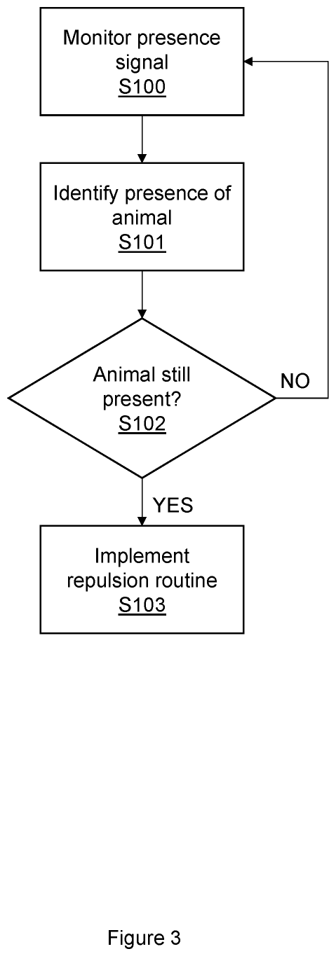

FIG. 3 shows a method implemented by the deterrence processing module 13 for determining the presence of an animal in the vicinity of the optical apparatus 20, according to an embodiment.

At step S100, the deterrence processing module 13 monitors the presence signal received from the detector system 11.

At step S101, the deterrence processing module 13 identifies, from the presence signal, an instance of an animal being detected within the vicinity of the optical apparatus 20.

Optionally, at step S102, the deterrence processing module 13 performs a temporal check to determine if the presence signal has indicated the presence of the animal for at least a predefined time.

In this case, in response to the predefined time elapsing with the animal still being detected as present, the deterrence processing module 13 proceeds to implement one or more repulsion events via repulsion system 12, at step S103. Where the optional temporal check is not utilised, the method proceeds directly to step S103. In response to the animal not being present after the predefined time elapsing, the method returns to step S100.

The repulsion system 12 is controlled by the deterrence processing module 13 to perform one or more repulsion events. According to an embodiment, there is a single repulsion event. Advantageously, a single repulsion event may simplify operation of the system 10. According to another embodiment, there are a plurality of repulsion events including an initial repulsion event and at least one subsequent repulsion event. Advantageously, multiple repulsion events provide for an escalation capability of the system 10—that is, a subsequent repulsion event may provide a better chance of repelling the animal when compared to an earlier repulsion action. The, or each, repulsion event comprises one or more repulsion actions.

Referring back to FIG. 2, there can be provided a non-physical repulsion action such as an audible repulsion action comprising emitting a sound and/or visual repulsion action comprising directing a light towards the animal. For example, the system 10 can comprise a speaker 24 and/or a light source 25 (which may provide for a bright flash). According to an embodiment, an initial repulsion action is a non-physical repulsion action. Advantageously, such initial repulsion action may require relatively low energy usage to instigate, does not affect the operation of the environment monitoring system 20, and/or does not require a physical interaction with the animal.

In an embodiment, the deterrence processing module 13 is further configured to determine a distance of detected objects from the environment monitoring apparatus 20. The distance is compared to a predefined minimum distance (which may be set by a user or communicated to the deterrence processing module 13) such that the deterrence processing module 13 determines whether the object is closer to or further from the environment monitoring apparatus 20 than the predefined minimum distance. It is expected the predefined minimum distance would be about 1 m for most situations, however the predetermined minimum distance could be varied depending on the specific arrangement of the apparatus, the wildlife to be detected and the environment. For example, for more effective integration with at least one of the sensors, i.e. the microwave movement sensor, the predefined minimum could be less than 1 m. Thus, the predefined minimum distance can be in the range of between 0.75 m to 1.25 m or 0.5 m to 1.0 m. In the event that the object is closer than the predefined minimum distance, the repulsion system 12 is not activated.

For example, it is expected that animals, in particular flying animals such as birds, are usually initial detected further away than the predefined minimum distance to the environment monitoring apparatus 20. Therefore, this embodiment may advantageously reduce or avoid instances of activation of the repulsion system 12 due to non-animal objects being detected by the detector system 11. A particular example of a non-animal object is detection due to environmental factors such as rain. Although the embodiment may result in non-activation of the repulsion system 12 when an animal is in fact present (due to an object, corresponding to the animal, being detected too close or, for example, being present during rain), this may be preferred in certain implementations when compared to activation occurring when not needed (due to, for example, measurement interference or power supply considerations).

In an implementation, the detector system 11 itself is configured for providing distance information—that is, not simply a presence or absence of an object, but further, a distance to said object. For example, where the detector system 11 utilises a radar sensor. In a particularly preferred example, the radar sensor is a radar transceiver having characteristics of being low cost, compact, and able to operate stably over a range of temperatures. In another implementation, a separate sensor is provided for determining whether the object is within the predefined minimum range.

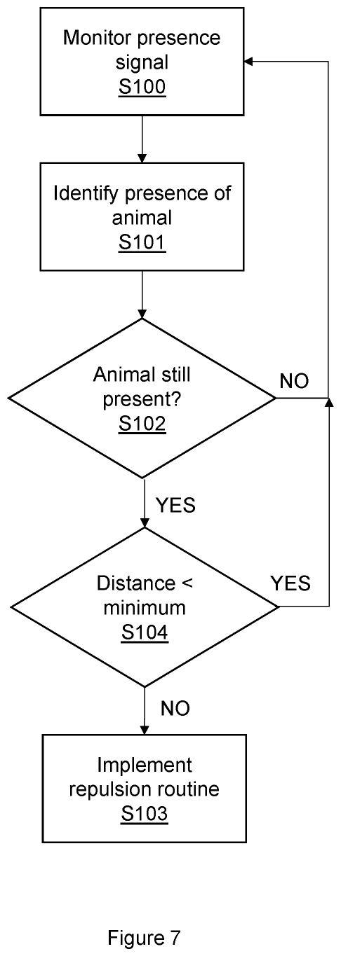

FIG. 7 shows a modification to the method of FIG. 3, and steps S100-S103 are equivalent. At additional step S104, the deterrence processing module 13 performs a distance check to determine whether the object is present within the predefined minimum distance. In this case, the method returns to step S100 without taking a repulsion action. Otherwise, the deterrence processing module 13 proceeds to implement one or more repulsion events via repulsion system 12, at step S103.

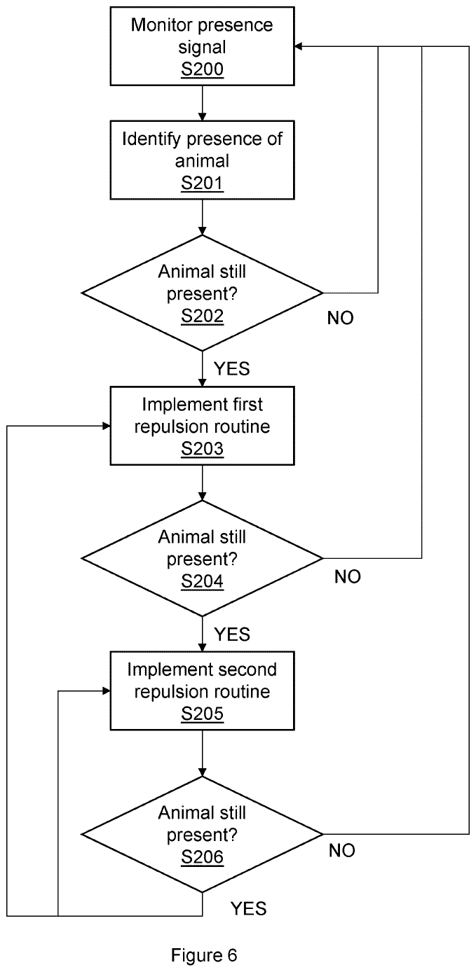

Although S104 is shown, in FIG. 3, as being performed after step S102, it can be understood that the two steps may be interchangeable within the method or may be effectively performed simultaneously. It should be clear that the method of FIG. 6 may similarly be modified to include a check against the predefined minimum distance.

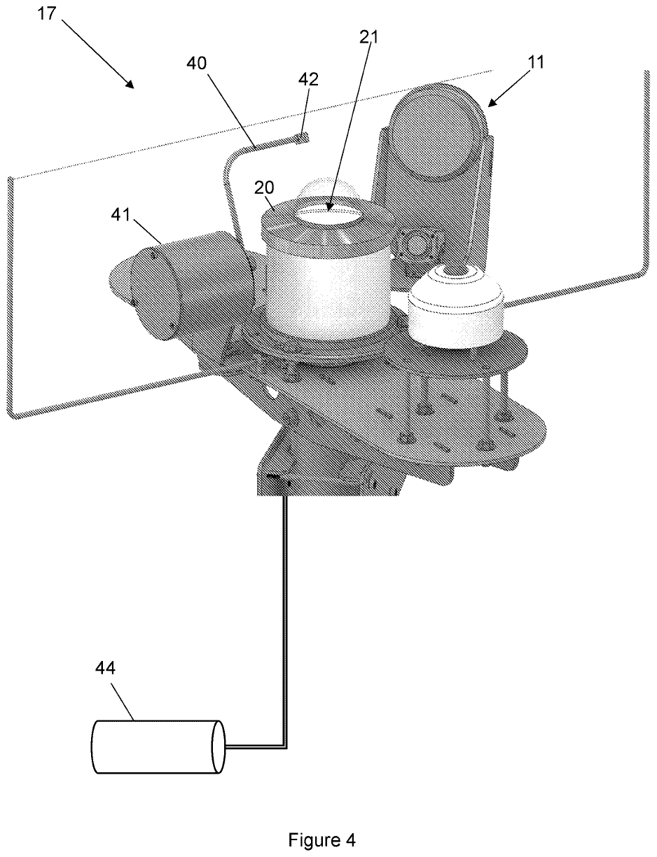

Referring to FIG. 4, according to an embodiment, a self-cleaning system 17 is provided configured to undertake a cleaning action in order to remove interference from the environment monitoring system 20. For example, such interference includes dust and dirt. The self-cleaning system 17 comprises a cleaning arm 40 coupled to a drive unit 41. The drive unit 41 is configured to cause a movement of the cleaning arm 40. The cleaning arm 40 comprises a nozzle 42 to which liquid can be supplied from a reservoir 43. A pump 44 is provided to effect movement of the liquid to the nozzle 42, for example, via conduit 45. Note that FIG. 4 also shows elements of the deterrence system 10 previously described.

In other embodiments, the cleaning arm 40 can have more than one nozzle 42 or the system can have multiple cleaning arms 40 which can have one or more nozzles or heads 42. In either case, the system according to these embodiments comprises multiple nozzles 42. The self-cleaning system 17 can also comprise a valve system having one or more valves 46 which can be controllably opened and closed so as to direct movement of water from the reservoir 43 to selected one or more of the nozzles 42, for example, according to a predefined cleaning routine. For example, the valves can be electrically controllable valves such as solenoid valves, but other controllable valves can be used. In an implementation, sufficient controllable valves 46 are provided such that each nozzle 42 can be individually activated (and deactivated) for cleaning. In another implementation, the nozzles 42 are arranged into two or more groups, each comprising one or more nozzles 42, and the valves 46 are arranged such that each group of nozzles 42 is individually controllable such that all nozzles 42 of a particular group can simultaneously be activated (and deactivated) for cleaning.

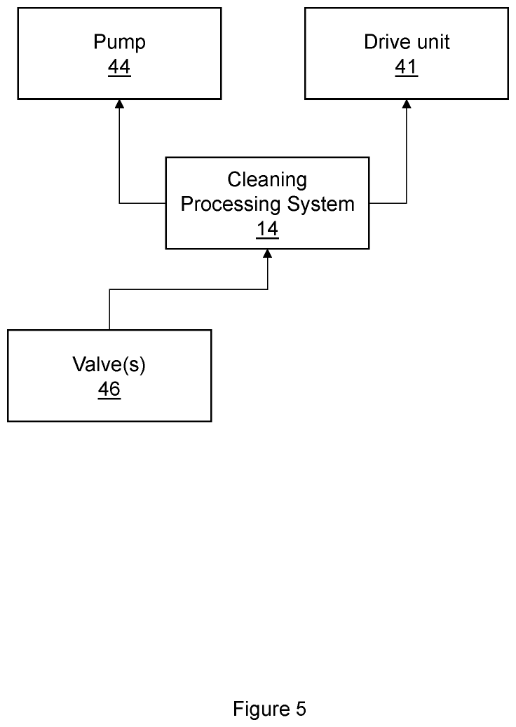

Referring to FIG. 5, according to an embodiment, the drive unit 41 and pump 44 can be controllable via cleaning processing module 14, or at least, each may undertake a predefined operation in response to a signal generated by the cleaning processing module 14.

According to an embodiment, the cleaning processing module 14 is configured to activate the drive unit 41 and the pump 44 from time to time, for example, according to a predefined schedule or periodically according to a predefined period. Such activation can be termed a cleaning action. During a cleaning action, the cleaning arm 40 is moved by the drive unit 41 and liquid is pumped out of the nozzle 42 via operation of the pump 44. The nozzle 42 is moved along a path and is generally configured to spray the liquid towards the environment monitoring apparatus 20. In particular, onto an active area of the environment monitoring apparatus 20 such as a lens or window through which an optical sensor 21 operates. The movement of the cleaning arm 40 results in the nozzle 42 being directed over the entire active area, or at least, a substantial portion of the active area to effect useful cleaning of the active area. The sprayed liquid acts to remove dirt and dust, and other contaminants.

In an embodiment where there are multiple nozzles 42, the cleaning processing module 14 can be configured to control the pump 44 and the valve system 46 so as to cause a movement of liquid from the reservoir 43 to a first one of the multiple nozzles 42 (or a first group of one or more nozzles 42) such that the liquid exits that first nozzle 42 (or one or more nozzles 42 of the first group) to contact at least a part of the active area. Then the cleaning processing module 14 is configured to control the pump 44 and valve(s) 46 to cause a movement of liquid to a second one of the multiple nozzles 42 (or a second group of one or more nozzles 42) to contact a different part of the active area (there may, of course, be overlap in the coverage of the active area). This then repeats, if applicable, for a third, fourth and so on, for each nozzle 42 in succession to perform a sequence of nozzle emissions until the entire active area is contacted by the liquid thereby cleaning the active area.

By only activating one nozzle 42 (or a group of the multiple nozzles 42) at a time, the pressure of the liquid exiting the nozzle 42 is improved when compared to activating all nozzles 42 at the same time. Therefore, the embodiment may advantageously optimise the cleaning ability of the liquid. By having the nozzles 42 arranged so as to have the exiting liquid contact at least part of the active area by a single nozzle at maximal pressure and the sequence of nozzles 42 activated in succession so as to cause substantially the entire area to be cleaned, the cleaning process is more efficient and effective. In the case of groupings of nozzles 42, an advantage may be provided by allowing for a desired trade-off between cleaning time (and therefore energy use) and the desire for higher pressure.

Referring back to FIG. 2, the reservoir 43 can be located at, or near, the base of pole 22—the conduit, which can include flexible and/or non-flexible tubing, couples the reservoir 43 and the nozzle 44 by extending up the pole 22. Advantageously, the reservoir 43 being at the base of the pole 22 may enable easy access for refiling and may reduce a weight loading on the pole 22. The pump 44 can be located near the reservoir 43.

The self-cleaning system 17 advantageously enables for cleaning of the environment monitoring apparatus 20 in an automated manner—there is no requirement for a user to be present. Thus, the time over which the environment monitoring apparatus 20 may be utilised without intervention by a user can be extended.

According to an embodiment, the self-cleaning system 17 may also be utilised for a repulsive action. For example, the cleaning arm 40 is moveable along a path which moves over the environment monitoring apparatus 20. This motion may provide an incentive to any animal that moves into the vicinity of the environment monitoring apparatus 20 to then move away. Thus, the associated repulsion action corresponds to movement of the cleaning arm 40, optionally along the same entire path as utilised during cleaning, such as to cause the cleaning arm 40 and nozzle 43 to physically interfere with the animal or at least scare the animal from landing on the environment monitoring apparatus 20. This repulsive action may be considered a physical repulsion action as it physically interferes with the animal's ability to reach or stay perched on the environment monitoring apparatus 20. Generally, it is not required that liquid is involved when using the cleaning arm 40 for repulsion—that is, the pump 44 is not necessarily activated.

Advantageously, this embodiment can utilise the same hardware for both cleaning and repulsion of animals, providing for fewer components when compared to two separate systems. Also, this embodiment may have the advantage of reducing or eliminating the incidence of bird droppings being deposited on the environment monitoring apparatus 20—such droppings may be more difficult to remove than dirt and dust.

Thus optionally, the self-cleaning system 17 can be further configured to perform a soaking step before the cleaning step which has been described above. In this soaking step, the pump, path and/or nozzles 42 are configured to cause the liquid to exit one or more the nozzles 42 so as to cover the active area and to allow it to soak into any mud or droppings. After a predetermined period of time (selected to allow the liquid to soak the mud or dropping sufficiently), the self-cleaning system 17 can then be configured to perform the cleaning step. It is envisaged that high water pressure is likely not necessary or of lower nee, and therefore multiple nozzles, if not all the nozzles 42, may be employed to perform the soaking. Further only a small amount of liquid is likely required and therefore the nozzles 42 are only utilised for a short period of time for soaking.

The processing modules 13, 14 can be implemented by a programmable logic controller (PLC), microcontroller, single-board computer (for example, a Raspberry Pi™), a miniPC, or any other suitable processor hardware. The processing module 13, 14 can be implemented within separate hardware or as functionality of the same hardware. Typically, the hardware comprises input/output ports (I/O ports) which can interface with the controllable features of the system 10, thereby enabling the processing module 13, 14 to implement the functionality herein described.

According to an embodiment, a power supply of the system 10 comprises a low voltage grid connected power supply or a solar power generator and a battery. Said solar power generator may be configured to charge the battery and/or power the system 10 directly. The battery can be configured to provide a power supply to the system 10 in an event of a low to no energy output of the solar power generator.

According to an embodiment, the system 10 is configured for recording data corresponding to the measured environment variable into memory (typically time stamped) and/or communicating said measured environment variable to an external computer. The communication may be by a wired or wireless data communication, for example, selected from mobile broadband options such as 4G or 5G, wired ethernet or DSL, or other wireless technologies such as LoRa (trade mark) LPWAN (Low Power Wide Area Network), or an alternative LPWAN such as a SIGFOX (trade mark) LPWAN or an Ingenu (trade mark) RPMA (Random Phase Multiple Access) LPWAN, and WiFi (in particular, directed WiFi).

FIG. 6 shows a method for deterring animals according to an embodiment, comprising a first repulsion event and a second repulsion event. For example, the first repulsion event comprises a non-physical repulsion action such as an audible repulsion action, a video repulsion action, or a combination of the two, and the second repulsion event comprises a physical interference action.

At step S200, the deterrence processing module 13 monitors the presence signal received from the detector system 11.

At step S201, the deterrence processing module 13 identifies, from the presence signal, an instance of an animal being detected within the vicinity of the environment monitoring apparatus 20.

Optionally, at step S202, the deterrence processing module 13 performs a temporal check to determine if the presence signal has indicated the presence of the animal for at least a predefined time.

In this case, in response to the predefined time elapsing with the animal still being detected as present, the deterrence processing module 13 proceeds to implement the first repulsion event, at step S203. Where the optional temporal check is not utilised, the method proceeds directly to step S203. The first repulsion event may be implemented for a predefined period of time.

The deterrence processing module 13 then checks for the presence of the animal after a predefined time from initiating the first repulsion event, at step S204. The predefined time may be equal to a time period over which the first repulsion event is performed or may be a different time, depending on the embodiment.

If the animal is not detected as present, the method reverts to step S200.

On the other hand, if the animal is still present, the method proceeds to step S205. Here, the second repulsion event is performed—for example, a physical repulsion action is performed which may result in a physical interference with the animal.

The deterrence processing module 13 then checks for the presence of the animal after a predefined time from initiating the second repulsion event, at step S206. The predefined time may be equal to a time period over which the second repulsion event is performed or may be a different time, depending on the embodiment.

If the animal is not detected as present, the method reverts to step S200. On the other hand, if the animal is still present, the method reverts to step S205 or step S203, depending on the embodiment.

Other physical repulsion actions are envisaged, depending on the embodiment. For example, in an embodiment not comprising self-cleaning system 17, a moveable arm may be provided that is similar in operation to cleaning arm 40, except that, no nozzle 42, reservoir 43, pump 44, or conduit 45 is provided.

An advantage of two or more repulsion events may be that a relatively low power and/or low intervention initial repulsion event may, in some cases, be sufficient to deter an animal. However, if the initial repulsion event is unsuccessful, the system 10 has capacity to escalate the repulsion using the subsequent repulsion event-which may involve physical movement. An advantage of utilising a non-physical repulsion action as the initial repulsion action is that it may reduce the instances of wear due to physical movement of components of the system 10.

The deterrence system 10 and/or self-cleaning system 17 can be utilised within a solar farm. The solar farm may be provided with one or more environment monitoring apparatuses 20 configured to assist in local weather forecasting, for example, by including an upward facing camera (optical sensor 21) configured to image the sky. The deterrence system 10 can be utilised to deter animals, particularly birds, from interfering with the operation of the optical sensor 21 by deterring the animals from resting on or otherwise coming into contact with the environment monitoring apparatuses 20. Solar farms are often located in remote or semi-remote locations, where it is impractical for people to visit regularly enough to provide cleaning of the environment monitoring apparatuses 20—the deterrence system 10 may therefore reduce the rate at which impurities are deposited onto the environment monitoring apparatuses 20 due to animals. Similarly, the self-cleaning system 17 can advantageously provide for autonomous self-cleaning of the optical sensor 21, thereby maintaining the one or more environment monitoring apparatuses 20 as effective tools for local weather forecasting.

The system 10 can be configured to record, in a memory, a log recording times at which a repulsion event has occurred. In an embodiment in which a cleaning arm 40 is moved in accordance with at least one repulsion action, a record of a time at which this occurs may enable correlation with data obtained from the environment monitoring apparatus. For example, this may enable subsequent processing to exclude data that is contemporaneous with the movement of the cleaning arm 40. In such an embodiment, a log may also be made of times at which a cleaning action has occurred, for similar reasons. In addition, or alternatively, the system 10 can communicate the record to an external computer (where applicable).

Embodiments can comprise a communication system (not shown) which is configured to communicate with the external computer (when located remotely) (e.g. to enable communication with the self-cleaning system 17 and/or the deterrence system 10 and the external computer). Specifically, the self-cleaning system 17 or deterrence system 10 can be configured to receive commands from the external computer to control one or more of the cleaning processing system 14, deterrence processing system 13, environment monitoring apparatus 20, repulsion system 12 and/or the self-cleaning system 17 remotely. In an example, the external computer may issue commands to activate or deactivate one or more of the systems, to put it to sleep, or to perform additional actions as required.

The communication system may also allow communication and monitoring of various events by the external computer, such as detection of presence of animals, level of water in the reservoir 43 (e.g. as determined by a reservoir level sensor (not shown) configured to monitor an amount of water present within the reservoir 43 and interfaced with self-cleaning system 17), charging cycles of the battery, instances of self-cleaning event, instances of repulsion events and the like, such as may be recorded in a log by the system 10. In particular, this information may be advantageously beneficial in identifying the particular requirements of a deployed system 10. For example, one system 10 may require a larger battery due to a larger number of required repulsion events when compared to another system 10, simply due to location, and this can be identified via such monitoring communications.

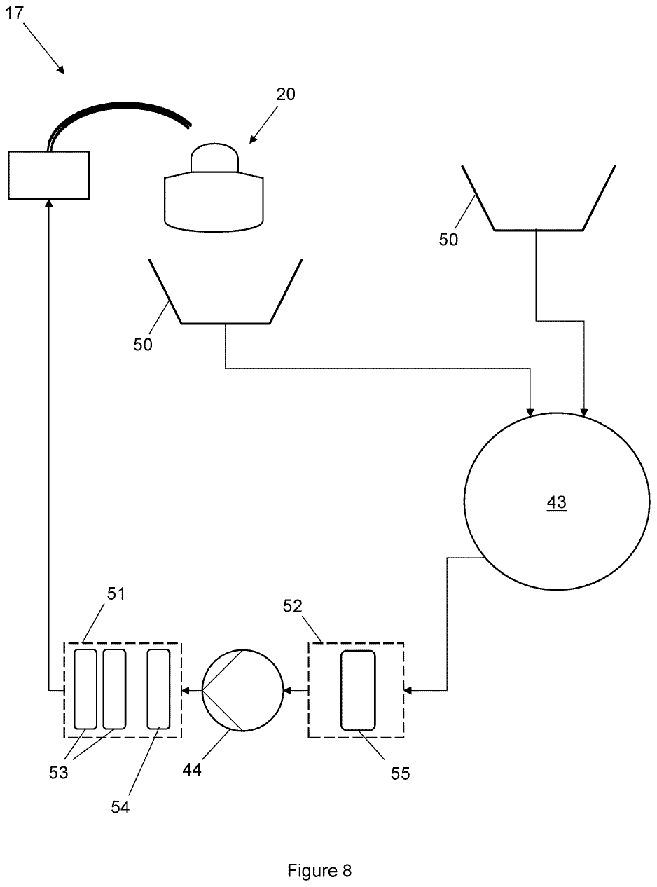

FIG. 8 shows an embodiment comprising a water collection system 15 integrated with the self-cleaning system 17. It is assumed that the self-cleaning system 17 is integrated with the described deterrence system 10, however features of deterrence system 10 are not explicitly shown in FIG. 8 for clarity. In an optional variation, the deterrence features described herein are not incorporated. Generally, the functionality of the self-cleaning system 17 may be according to an embodiment herein described, the effect of which is to effect cleaning of the active area by directing water supplied by the reservoir onto the active area of the environment monitoring apparatus 20. The deterrence system 10 may advantageously work together with the self-cleaning system 17 and water collection system 15 to further reduce the number of visits required by a user to an associated environment monitoring apparatus 20 by reducing the probability of the active area of the environment monitoring apparatus 20 receiving visual spoilage due to the activities of animals, thereby reducing the amount of self-cleaning required, while also providing ongoing cleaning of the active area for extended periods between visits due to the capacity for the water collection system 15 to maintain a useable level of fluid for use by the self-cleaning system 17.

The embodiment of FIG. 8 may advantageously allow the reservoir 43 to be replenished with water to reduce the frequency of maintenance of the self-cleaning system 17 (and, more generally, the environment monitoring apparatus 20). That is, a user is required to visit the environment monitoring apparatus 20 less often which may advantageously improve its utility as a remote environment monitoring apparatus 20.

The water collection system 15 is configured to collect water from the environment surrounding the environment monitoring apparatus 20.

In an implementation, the water collection system 15 comprises one or more collectors 50 having a structure and positioned such as to collect water used by the self-cleaning system 17 when cleaning the active area of the environment monitoring apparatus 20. In an implementation, the water collection system 15 comprises one or more collectors 50 having a structure and positioned such as to collect water from local precipitation. It is expected that one or more collectors 50 can combine such functionality-having a structure and positioning suitable for collecting water both water used by the self-cleaning system 17 when cleaning the active area of the environment monitoring apparatus 20 and water from local precipitation.

A collector 50 typically comprises an ingress opening arranged to receive water from above (i.e. water falling under gravity). For example, a collector 50 can be configured as a collection tray. The, or each, collector 50 is in fluid communication with the reservoir 43. In an example, via flexible and/or non-flexible tubing. In an example, a collector 50 is directly coupled to the reservoir 43, for example, by having a lower egress opening directly coupled to an ingress opening of the reservoir 43.

In an embodiment, the fluid communication between the, or each, collector 50 and the reservoir 43 is achieved via gravitation only—that is, no active pumping mechanism is provided. Advantageously, this avoids the need for additional pumps (noting that pump 44 is required to operate the self-cleaning system 17). However, in certain embodiments, a pump (not shown) can be provided between at least one collector 50 and the reservoir 43; this may be advantageous in situations where at least one collector 50 cannot be positioned suitably above the reservoir 43 for gravitational action (e.g. due to physical constraints at the site of the associated environment monitoring apparatus 20.

FIG. 8 also shows a filtration system 60 for filtering water within the self-cleaning system 17. In the embodiment shown, the filtration system 60 is arranged to filter water pumped from the reservoir 43 by pump 44. Thus, advantageously, the same pump 44 is utilised for both forcing water through the filtration system 60 as well as operating the self-cleaning system 17, while ensuring that water is filtered before being directed onto the active area of the environment monitoring apparatus 20.

Another embodiment (not shown) positions the filtration system 16 in the fluid path between the water collection system 15 and the reservoir 43. Although this embodiment likely requires an additional pump (not shown) to ensure effective filtering of the environmental water, it may provide an advantage in ensuring that the self-cleaning system 17 itself only contains filtered water (as the water is filtered before entering the self-cleaning system 17). Such an additional pump can be controlled by the cleaning processing module 14 and may require the one or more collectors 50 be suitable for holding collected water until said additional pump is activated, or the provision of one or more secondary storage tanks (not shown) between the one or more collectors 50 and the reservoir 43.

The filtration system 16 comprises a first filter unit 51 in fluid communication with, and between, pump 44 and the nozzle 42 such that the first filter unit 51 is arranged on an output side of pump 44. Alternatively, or in addition, the filtration system 16 comprises a second filter unit 52 in fluid communication with, and between, reservoir 43 and pump 44 such that the second filter unit 52 is arranged on a suction side of pump 44.

In an embodiment, the filtration system 16 comprises a deionising filter 53 comprising two deionising resin filters in series. In an embodiment, the filtration system 16 comprises a carbon pre-filter 54 arranged to filter received water before it reaches the deionising filter 53. In an embodiment, the filtration system 16 comprises a strainer 55 for removing relatively large particles. In the implementation shown, the first filter unit 51 comprises the deionising filter 53 and the carbon pre-filter 54 and the second filter unit 52 comprises the strainer 55.

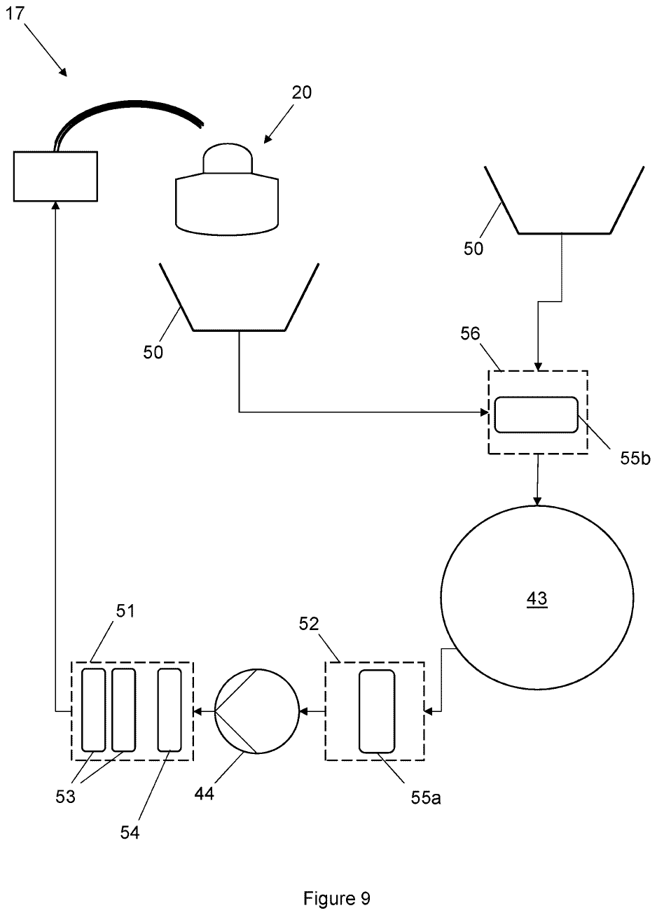

FIG. 9 shows a variation to the embodiment of FIG. 8 in which a second strainer 55b is arranged as a component of a third filter unit 56 arranged in fluid communication with, and between, the one or more collectors 50 and the reservoir 43. In the embodiment shown, the second strainer 55b is in addition to a first strainer 55a of the second filter unit 52 (as previously described). However, in a variation (not shown), the second strainer 55b replaces the first strainer 55a (i.e. there is no strainer 55 in fluid communication with, and between, the reservoir 43 and the self-cleaning system 17. The third filter unit 56 can comprise other filters to the second strainer 55b. However, an advantage of locating a second strainer 55b at the third filter unit 56 may be that the second strainer 55b is able to effectively filter under gravitational induced fluid pressure without the need for active pumping. An advantage of a second strainer 55b arranged before the reservoir 43 as shown may be that large debris are impaired from entering the reservoir 43 in the first place.

According to an embodiment, an environment monitoring apparatus 20 is provided which can advantageously clean its own instruments, detect and deter wildlife, and collect and filter its own water. In optional configurations, the inclusion of a power supply comprising a solar power generator and battery, can enable the environment monitoring apparatus 20 it produces its own power. Advantageously, such environment monitoring apparatuses 20 are thereby suitable for installation in remote locations. For example, such an environment monitoring apparatus 20 can advantageously reduce the need for cleaning and water top-up by a user.

Advantageously, incorporation of a filtration system 16 may enable the reservoir 43 to be topped up with potable water by a user visiting the location of the environment monitoring apparatus 20, rather than deionised water, if insufficient rainfall is available. Although this requires user intervention, it does not necessarily require the user to have with them suitably filtered water for cleaning the active area of the environment monitoring apparatus 20.

As shown in FIG. 8, in an embodiment, the output of the reservoir 43 is higher than the bottom of the reservoir 43. This can advantageously provide a volume of the reservoir 43 for contaminants to settle which will then not be fed (at least, a substantial portion of the settled contaminants) into the self-cleaning system 17, thereby providing, in effect, an additional filter.

In an embodiment, the, or each, collector 50 is arranged within an effective deterrence distance of the deterrence system 10. Advantageously, this can reduce the probability of debris entering the reservoir 43 due to the action of local wildlife—for example, an effective bird deterrence can reduce the risk of feathers, droppings, and other bird-caused contaminants entering the collector(s) 50.

In an embodiment, at least one collector 50 comprises, at least in part, a solar panel of a solar power generator utilised by the environment monitoring apparatus 20 and/or features of the various systems herein described.

Further modifications can be made without departing from the spirit and scope of the specification.

For example, the system 10 may be configured to account for a relative distance of an animal to the environment monitoring apparatus 20 when selecting between two or more different repulsion events (see, for comparison, the method of FIG. 6). Accordingly, the detector system 11 may be configured to determine a relative distance of an animal as well as the presence of the animal. The system 10 can be configured to apply one repulsion event when the animal is present at a first distance and another repulsion event when the animal is present at a second distance. Advantageously, such a configuration may enable a non-physical repulsion action to occur when the animal is still some distance from the environment monitoring apparatus 20 and a physical repulsion action when the animal is closer to the environment monitoring apparatus 20.

1. A self-cleaning system for autonomous cleaning of an environment monitoring apparatus having an active area, the system comprising:
a reservoir;
a self-cleaning system in fluid communication with the reservoir and configured for cleaning of the active area by directing water supplied by the reservoir onto the active area;
a water collection system for collecting and inputting into the self-cleaning system water external to the self-cleaning system, wherein the water collection system is in fluid communication with the reservoir; and
a filtration system for filtering water within the self-cleaning system,
wherein the filtration system comprises a first filter unit in fluid communication with, and between, the reservoir and the self-cleaning system.

2. (canceled)

3. The system of claim 1, comprising a first pump for pumping water from the reservoir to the first filter unit and subsequently to the self-cleaning system.

4. The system of claim 3, wherein the first filter unit comprises a deionising filter, and/or a carbon filter arranged to filter received water before said the deionising filter.

5. (canceled)

6. The system of claim 4, further comprising a second filter unit in fluid communication with, and between, the reservoir and the first filter unit.

7. (canceled)

8. The system of claim 6, wherein the second filter unit is arranged at a suction side of the first pump.

9. The system of claim 1, wherein, in use, a direction of flow of water is from the reservoir through the first filter unit and on to the self-cleaning system.

10. The system of claim 6, further comprising a third filter unit in fluid communication with, and between, the water collection system and the reservoir.

11. The system of claim 10, wherein the second filter unit and/or third filter unit comprises a strainer.

12. The system of claim 1, wherein the water collection system comprises at least one first collector arranged to receive water expelled by the self-cleaning system, such that at least a portion of water used for cleaning the active area is captured by the at least one first collector.

13. (canceled)

14. The system of claim 1, wherein the water collection system comprises at least one second collector arranged to receive environmental water, such as rain.

15. The system of claim 14, wherein the at least one first collector and/or the at least one second collector comprises a collection tray in fluid communication with the reservoir arranged such that captured water is directed to the reservoir.

16. (canceled)

17. The system of claim 1, wherein the water collection system utilises gravity to deliver captured water to the reservoir.

18. The system of claim 1, wherein the reservoir comprises an output port for providing water to the self-cleaning system, said output port arranged above a lower volume of the reservoir defining a volume for particulate material to settle.

19. The system of claim 1, further comprising a deterrence system for deterring animals from a vicinity of an environment monitoring apparatus.

20. The system of claim 19, wherein the deterrence system comprises:
a detector system comprising at least one sensor configured to generate a presence signal indicative of the presence of an object within a predefined vicinity of the environment monitoring apparatus;
a deterrence processing system; and
a repulsion system,
wherein the deterrence processing system is configured to:
monitor the presence signal; determine, from the presence signal, the presence of an object within the predefined vicinity of the environment monitoring apparatus; and
communicate a command for the repulsion system to perform a sequence of one or more repulsion events actions in response to determining that an object is present, and
wherein the repulsion system is configured to: perform one or more repulsion events responsive to receipt of the command from the deterrence processing system.

21. The system of claim 19, wherein the deterrence system is configured to move a cleaning arm of the self-cleaning system through a path in which at least a portion of the cleaning arm moves within the vicinity of the environment monitoring apparatus such as to deter animals from a vicinity of an environment monitoring apparatus.

22. The system of claim 1, further comprising a solar power generator and a battery for providing electrical power to components of the system.

23. (canceled)

24. The system of claim 1, further comprising a communication system configured to communicate between an external computer and the self-cleaning system; and
wherein the self-cleaning system is further configured to receive commands from the external computer via the communication system for controlling the cleaning processing system, environment monitoring apparatus and/or self-cleaning system remotely, and/or to communicate monitoring information,
wherein the communication system utilises a wireless wide area communications protocol.

25. The system of claim 24, further comprising:
a reservoir level sensor configured to monitor an amount of water present within the reservoir,
wherein the self-cleaning system is configured to identify a low water event corresponding to an amount of water in the reservoir, as detector by the reservoir level sensor, being below a threshold amount, and to communicate an indication of the low water event to the external computer.

26. An environment monitoring apparatus comprising the system of claim 1, wherein the environmental monitoring apparatus comprises an active area for monitoring an environment of the environment monitoring apparatus, and wherein the self-cleaning system is configured for cleaning said active area, such that the environment monitoring apparatus is adapted for autonomous self-cleaning.

27. (canceled)

28. A solar farm comprising one or more systems, wherein system is as claimed in claim 1.
